(19) United States
(12) Patent Application Publication
(10) Pub. No.: US 2003/0229588 A1
(43) Pub. Date: Dec. 11, 2003

(54) Voice enabled electronic bill presentment and payment system

(75) Inventors: Elizabeth Ross Falk, Danbury, CT (US); Andrew Stewart Ross, McLean, VA (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/163,964

(22) Filed: Jun. 5, 2002

(51) Int. Cl. G06F 17/60

(52) U.S. Cl. 705/40

(57) ABSTRACT

A method for audibly providing billing services from an electronic billing server to a user in which telephone communication is established between the electronic billing server and the user such that billing details are provided in a spoken language from the electronic billing server to the user. The billing details provided by the electronic billing server relate to a billing account associated with the user and are contained in the electronic billing server. The user is enabled to provide payment instructions to the electronic billing server that relate to the provided billing information through the established telephony communication between the electronic billing server and the user. The electronic billing server then initiates an order from the electronic server to a user's bank to initiate the user's payment instructions.

### FIELD OF THE INVENTION

The present invention relates to a method and system for providing electronic billing presentation and payment of bills. More particularly, the present invention relates to an electronic billing presentment and payment of bills system that is voice enabled and operable by telephony methodology.

### BACKGROUND OF THE INVENTION

Conventional household bill payment is based on the receipt by mail of a paper statement from each service establishment for each billing period.

Households issue a multitude of paper checks and associated paper return stubs to these service establishments and the payments are cleared through banks, credited to service establishment bank accounts, and applied or credited to the household accounts on record. In this conventional system, for example, a city of 3 million households, each writing only 5 checks each month will generate more than 60 million paper transactions per month, or 720 million in a year.

Conventional payment systems are designed to handle these inefficient paper payments on a large scale, causing more efficient alternatives to actually increase costs, because they require special “exception” handling. Nevertheless, there has been substantial focus on electronic alternatives to paper checks and stubs. Typically, these electronic alternatives involve automating the consumer interface to enable the creation of electronic transactions, such as, for example, billing service bureaus, automatic teller machine payment, internet-based home banking, and electronic bill presentment and payment. However, households do not easily adopt new payment systems on a large scale, and receiving service establishments generally resist the associated exception costs. While Internet-based electronic bill presentment and payment may eventually come into widespread use, to date, commercially viable alternate payment technologies have had a negligible impact on reducing the inefficiencies inherent in conventional paper-based bill payment. One reason for the low adaptation rate of EBPP based systems is that many bill payer's still do not own computers, do not have computers coupled to the internet or are just not comfortable paying bill via their computer.

Thus, what is needed is an automated household bill payment system that eliminates paper-based bill payment and is user friendly. The system should be easily adaptable to household use on a large scale. The system further should be low cost to service establishments. The system further should not require electronics or automation at the household point of payment. The system should readily accommodate and directly facilitate the eventual transition to full electronic bill presentment and payment over electronic networks.

### SUMMARY OF THE INVENTION

A method for audibly providing billing services from an electronic billing server to a user in which telephony communication is established between the electronic billing server and the user such that billing details are provided in a spoken language from the electronic billing server to the user. The billing details provided by the electronic billing server relates to a billing account associated with the user, which billing details are contained in the electronic billing server. In a preferred embodiment, the electronic billing server may contain billing details relating to a plurality of billing accounts each associated with the user. Preferably, the billing server is configured to automatically establish telephony communication with a user preferably at a predetermined time each month, which is preferably determined by the user, to provide billing details associated with a billing statement for a user's billing account (e.g., a credit card, utility or loan billing statement). Alternatively, a user may establish telephony communication with the electronic billing server at any time to hear billing detail information from a selected billing account.

Once the user has heard the billing details, the user is then enabled to verbally respond to the electronic billing server, via telephony, to send payments instructions so as to initiate a bill payment regarding a user's billing account that is linked to the electronic billing server. The electronic billing server then preferably initiates an order from the electronic server to a user's bank to initiate the user's payment instructions.

### BRIEF DESCRIPTION OF THE DRAWINGS

The above and other objects and advantages of the present invention will become more readily apparent upon consideration of the following detailed description, taken in conjunction with accompanying drawings, in which like reference characters refer to like parts throughout the drawings and in which:

FIG. 1 depicts a block diagram of a prior art mail based billing system;

FIG. 2 depicts a block diagram of a prior art electronic billing presentment and payment system;

FIG. 3 depicts a block diagram of the present invention voice enabled electronic billing presentment and payement system; and

FIGS. 4-7 are flow chats depicting the method of use for the voice enabled electronic billing presentment and payment system.

### DETAILED DESCRIPTION OF THE PREFERRED EMBODIMENT

In describing the preferred embodiment of the present invention, reference is made to the drawings, wherein there is seen a Voice Enabled Electronic Billing Presentment and Payment (VEEBPP) system, designated generally by reference numeral 100, which is preferably used to enable bill presentment and payment, via telephony.

However, prior to discussing the preferred embodiment of the present invention, a brief discussion on the prior art techniques for achieving bill presentment and payment will be discussed in order to provide an appreciation of the present invention billing system.

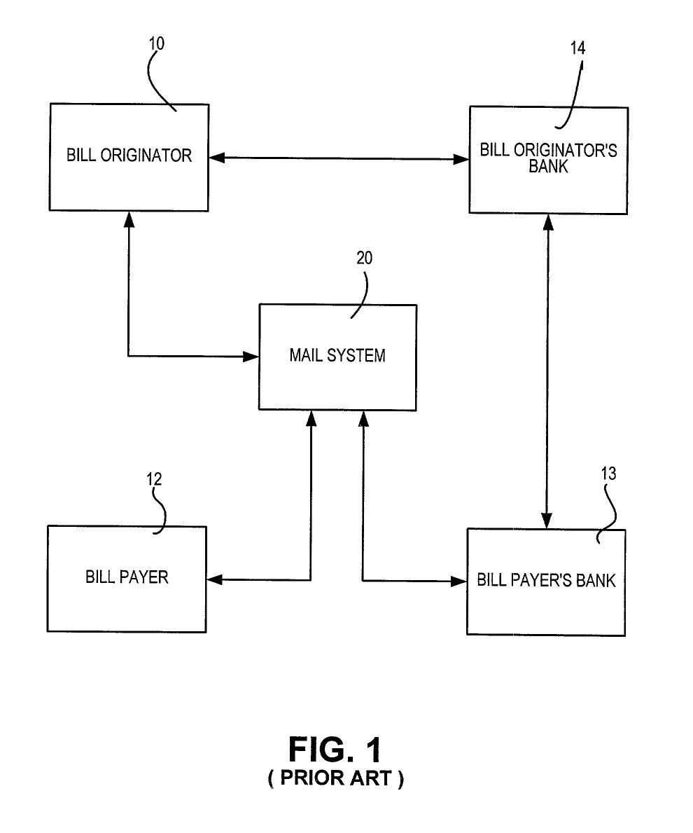

With reference now to FIG. 1, there is a schematic representation showing the well known mail based system and method for bill presentment and payment without the integration of an Electronic Billing Presentment and Payment (EBPP) system. This typically involved a bill originator 10, bill payers 12 and their bank 13. The bank for the bill originator is shown by 14.

In its well known use, the bill originator 10 sends a bill through the mail 20 to the bill payer 12. The bill payer 12 issues a check, encloses it in an envelope and sends it through the mail 20 to the bill originator 10. The bill originator 10 then preferably uses a carrier to transport the bill payer's check to the bill originator's bank 14. The bill originator's bank 104 then uses a carrier to transport the check to the bill payer's bank 13, then the bill payer's bank 13 returns the check to the bill payer 12, thus completing the cycle. The carriers and the mail are obvious sources of potential cost, delay and possibility of loss.

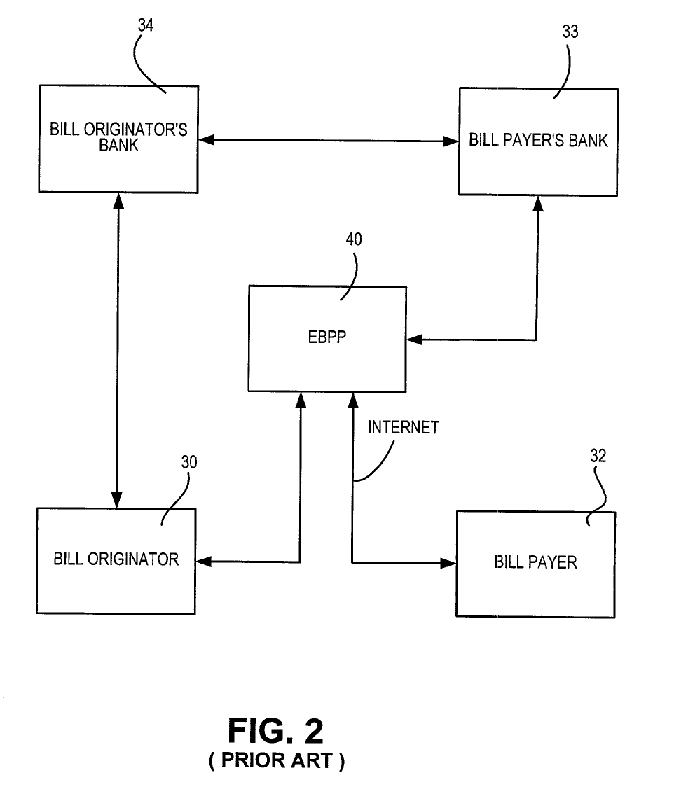

With reference now to FIG. 2, there is shown a current EBPP system illustrating bill originators 30, the bill payers or customers 32, the bill payer's bank 33 and the bill originator's bank 34 which preferably remain unchanged from the implementation in FIG. 1. The system of FIG. 2 obviously has the addition of an Electronic Bill Presentment and Payment (EBPP) system 40 being interposed into the system and allowing electronic bill presentation and payment. In its use, a bill originator 30 creates the information necessary to bill customers and then sends an electronic message to the electronic bill presenter 40. The electronic bill presenter 40 sorts the bills from at least one bill originator and presents the bills to the bill payer 32 in the form of an electronic bill. The bill payer 32 then indicates the bills that he wishes to be paid, the amounts of the payments by a return message or payment authorization to the electronic bill presenter 40. That payment authorization is then sorted by bank, and a message is presented to each of the banks 33 involved as associated with individual customers or bill payers 32. The bill payer's bank 33 then sends a message to the bill originator's bank 34 indicating a payment. The bill originator's bank 34 sends a message or payment notification to the bill originator 30, with detail as to the amount and customers involved. Meanwhile, the electronic bill presenter 40 has preferably sent a message indicating the reconciled payments to the bill originator 30 for comparison with the payment notification messages received from the bill originator's bank 34.

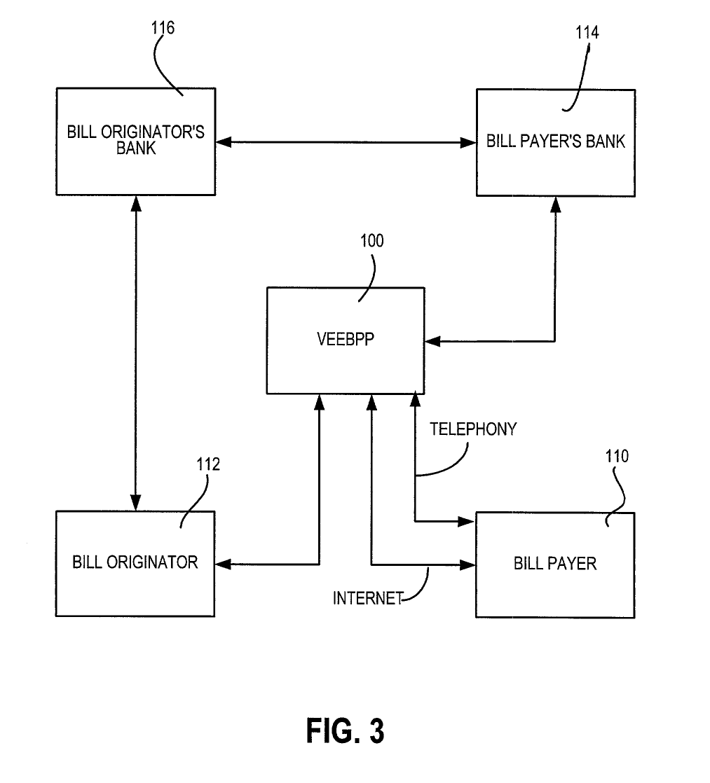

The preferred embodiment of the present invention will now be described with reference to FIG. 3, where there is shown the VEEBPP system 100 that is similar to the EBPP system 40 shown in FIG. 2 with the exception of the telephony communication 102 provided between the VEEBPP 100 and the bill payers 110. As will be described, it is the bill payers voice control of the VEEBPP 100 that embodies the present invention. It is to be understood that accompanying the telephone connection between the bill payers 110 and VEEBPP 100 is all the necessary hardware and software to enable such telephony communication, speech recognition and voice authentication technologies. It is further to be understood, that in addition to English, the speech recognition technology implemented in VEEBPP 100 is to support other languages as well, with the VEEBPP 100 being configured to preferably offer a selection of languages (e.g., English, Spanish, French, etc.) to be selected for use by the bill payer 110.

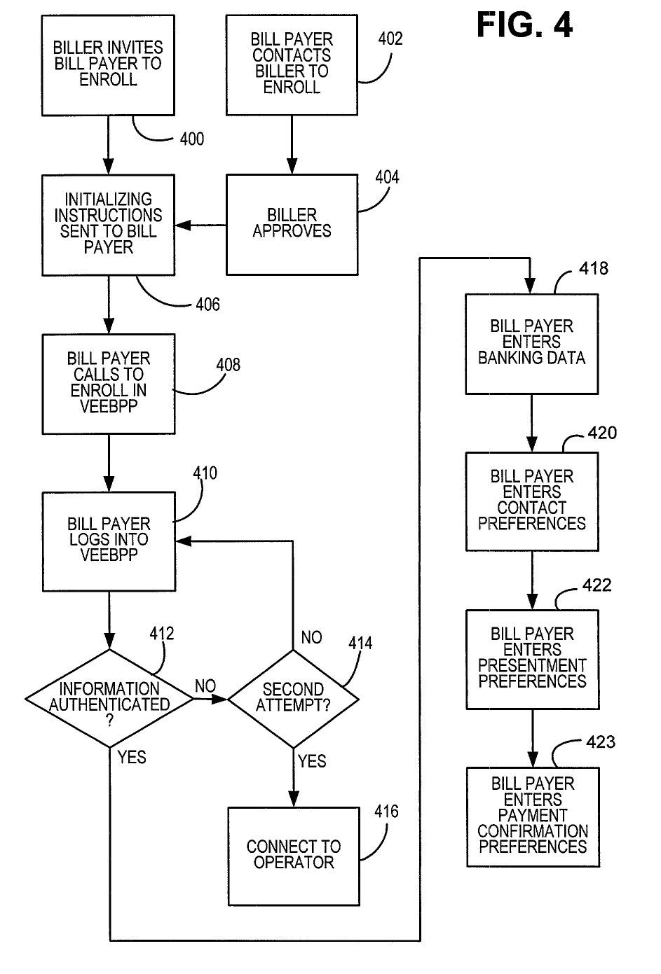

Beginning with reference to FIG. 4, the method of use of the present invention VEEBPP 100 will now be discussed. Initially, a biller 112 preferably invites a bill payer 110 to subscribe to the use of VEEBPP (step 400). Also, a bill payer 110 may contact a bill originator 112 to subscribe to the use of VEEBPP 100 (step 402). This may occur via the telephone (utilizing standard land lines, cellular technology or other method of sending/receiving voice), mail, website or e-mail. Afterwards, the bill originator 112 would then approve the bill payer 110 to subscribe to use of VEEBPP 100 (step 404). Upon either invitation or approval, instructions for initializing VEEBPP 100 are sent to the bill payer 110 (step 406). Preferably, these instructions contain a startup password and PIN, and for security purposes, may be sent to the bill payer 110 via either e-mail or conventional mail. Upon receipt of these instructions, the bill payer 110 then preferably enrolls in the VEEBPP 100 using the authentication provided in the initializing instructions (step 408).

Once a bill payer 110 is enrolled in VEEBPP 100, the bill payer 110 initializes VEEBPP 100 for the bill payer's use by dialing a telephone number associated with VEEBPP 100 and entering the bill payers 110 account number, password and PIN (step 410), which were previously sent to the bill payer 110 (step 406). This information may be entered into the VEEBPP 100 through either a telephone keypad or the bill payer's voice. In the event information is entered in the VEEBPP 100 through the bill payers voice 110, voice recognition software will naturally be used by VEEBPP 100. After this information is entered, the VEEBPP 100 verifies the accuracy of the entered information (step 412), and if determined not to be accurate, then a determination is made as to whether this was a second attempt for entering the information (step 414). If yes, then the VEEBPP 100 connects the bill payer 110 to preferably a live operator to assist in the bill payer's initialization of VEEBPP 100 (step 416). If this was only the bill payer's first attempt of entering the information then the aforesaid initialization process is repeated (step 410).

After it is determined that the proper bill payer initialization information has been entered (step 412), the bill payer 110 then preferably enters their banking information (or other payment method) into the VEEBPP 100 (step 418), (e.g., banking name, bank routing number and checking account number). The bill payer 110 then preferably enters their contact preferences (step 420), which preferences preferably include the retry frequency wherein if contact with the bill payer 110 is not made during a VEEBPP 100 initiated phone call, when should a second attempt by the VEEBPP 100 be made. The contact preferences may further include alternate presentment method and schedule, such that if the VEEBPP 100 is not successful in making telephony contact with the bill payer 110 during a certain time period, then what alternative methods are to be used (e.g., mail, facsimile, e-mail, etc.).

After the aforesaid contact preferences are entered into the VEEBPP 100, the bill payer 110 is then preferably prompted to enter bill presentment preferences (step 422). Preferably, the bill presentment preferences include the following options: 1)the VEEBPP 100 calls the bill payer to indicate bill details (e.g., bill total, itemized bill details, statement balance, etc.); 2)the VEEBPP 100 mails a bill statement to the bill payer 110; 3)the VEEBPP e-mails a bill statement to the bill payer 110; or 4) the VEEBPP 100 sends an e-mail to a bill payer 110 indicating a billing statement is available for viewing at a website preferably having a unique URL. It is also to be appreciated that indication that a billing statement is available for viewing may be provided to the bill payer 110 via any known means for providing such information (e.g., one-way and two-way pagers, facsimile devices, etc.)

After the aforesaid bill presentment preferences are entered into the VEEBPP 100, the bill payer 110 is then preferably prompted to enter bill payment confirmation preferences (step 423). Preferably, the bill payment confirmation preferences include the following options: 1) the bill payer 110 accesses the bill payment system to verify account activity; 2) the VEEBPP 100 e-mails a verification statement to the bill payer 110; 3) the VEEBPP 100 sends an e-mail to a bill payer 110 indicating a summary of the bill payer's account activity is available for viewing at a website preferably having a unique URL; 4) the VEEBPP 100 mails a verification statement to the bill payer 110.

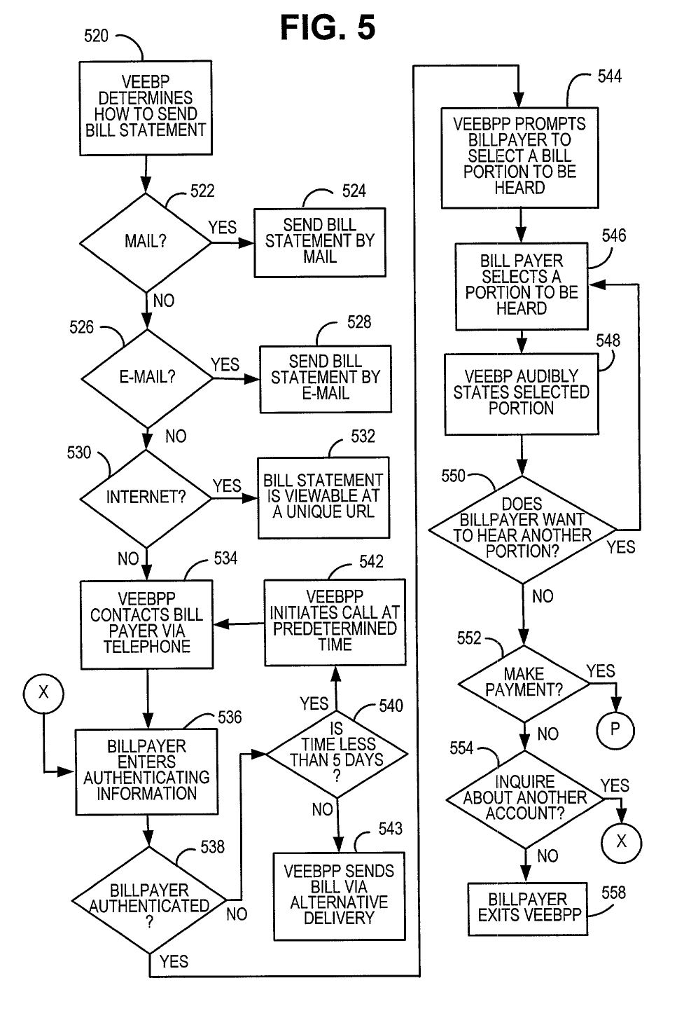

With the initialization of the VEEBPP 100 being described above, and with reference to FIG. 5, discussion will now turn the presentment of billing statements from the VEEBPP 100 to bill payers 110. In accordance with the aforesaid prescribed bill present preferences (step 418), the VEEBPP 100 determines how a billing statement is to be sent to a subscribing bill payer (step 520). If it is determined that the bill statement is to mailed (step 522), then the VEEBPP 100 generates a paper based statements and causes it to be mailed to the bill payer (step 524). If it is determined that the bill statement is to be e-mailed (step 526), then the VEEBPP 100 causes the bill statement to be e-mailed to the bill payer (step 528). If it is determined that the bill statement is to be viewed on a website at a unique URL (step 530), then the VEEBPP 100 posts the bill statement at the unique URL and preferably sends an e-mail to the bill payer indicating the bill is ready for viewing at the unique URL (step 532).If the subscribing bill payer 110 selected to receive the bill statement via telephony, then the VEEBPP 100 initiates a telephone call the bill payer 110 (step 534). Alternatively, the bill payer could initiate contact with the VEEBPP 100 by calling a predetermined telephone number (step 535). Upon telephone answer, the bill payer 110 is prompted by the VEEBPP 100 to verify proper identity (step 536). This preferably includes the entering any combination of the bill payer's name, membership number, billing account number, password or PIN. A determination is then made as to whether proper bill payer verification was achieved (step 538). If verification was not achieved and an alternate bill payer has subscribed to the system, the VEEBPP 100 will preferably request the alternate bill payer. If verification was not achieved, the VEEBPP 100 will leave a message for the bill payer 110, stating the identification of the biller, the date and time of the call, the purpose of the call, and the phone number by which the bill payer could initiate contact with the VEEBPP 100. If verification was not achieved, and the billing statement has not been generated for longer than a predetermined amount of time (step 540) (e.g., 5 days), then the VEEBPP 100 preferably records the unsuccessful contact and retries the telephone call (step 542) in accordance with the bill payer's 110 prescribed time preference for doing so (see, step 216). If verification was not achieved, and the billing statement has been generated for longer than a predetermined amount of time (step 540) (e.g., 5 days), then the bill statement is delivered in accordance with the bill payer's 110 prescribed alternate method (step 543).

Returning to the verification of the bill payer 110 (step 538), if proper verification has been achieved, then the VEEBPP 100 preferably prompts the bill payer 110 as to which portion of the bill statement, or the entire bill statement, they want to hear (step 544). For example, such bill portions may include: bill total; bill details; minimum payment; interest payment or payment due date. The bill payer 110 then preferably states which portion of the bill statement they want to hear (step 546). This can be accomplished through either voice command or the telephone keypad. The VEEBPP 100 then preferably audibly states the selected bill portion (step 548). A determination is then made as to whether the bill payer 110 wants to hear the selected information to be repeated again or hear another bill portion (step 550). If yes, the above process (step 546) is repeated again. If no, a determination is made as to whether the bill payer 110 wants to proceed with payment towards the notified bill statement (step 552). If the bill payer 110 does not want to proceed towards payment of the aforesaid bill statement, then a determination is made as to whether the bill payer 110 wants to hear another bill statement associated with a different bill account number (step 554). If yes, the VEEBPP 100 then prompts the bill payer 110 to enter that bill account number (step 556) and the aforesaid steps for reviewing a bill statement are repeated. If the bill payer 110 did not want to review another bill statement, then the current session with the VEEBPP 100 is closed with the bill payer 110 preferably being logged out (step 558).

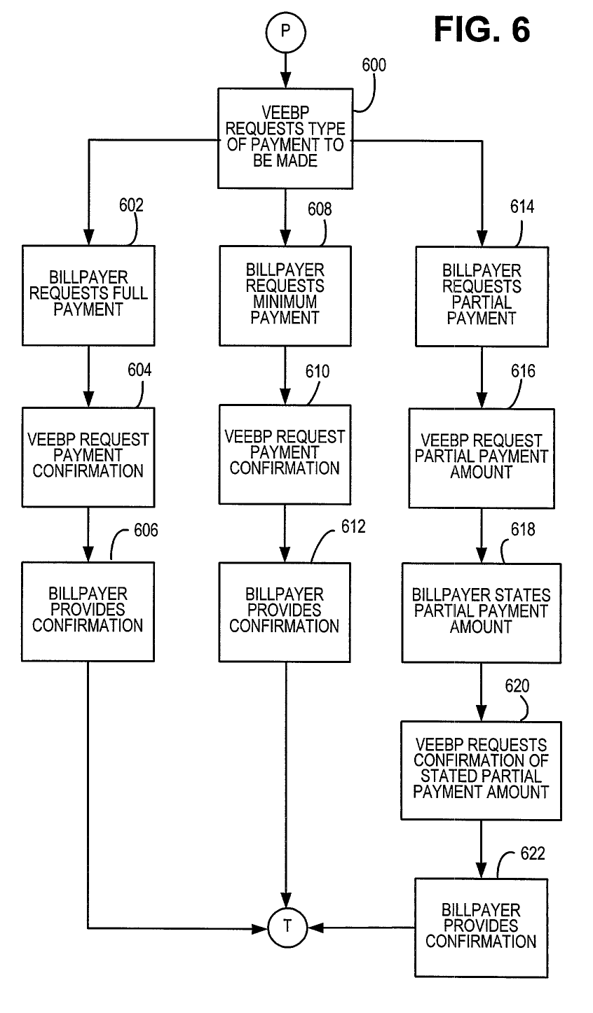

Returning to the aforesaid determination as to whether the bill payer 110 wants to proceed with payment towards notified bill statement (step 552), if yes, then the payment procedures specified in subroutine “P” (FIG. 6) are initiated. With reference now to FIG. 6, the VEEBPP 100 preferably prompts the bill payer for type of payment, namely: Full, Minimum or Partial (step 600). The bill payer may specify the type of payment and payment date at this point (step 624).

If the bill payer 110 wants to make a full payment, preferably on the outstanding balance owed, then the bill payer 110 preferably states “Full”, after which the VEEBPP 100 preferably provides audible notification of the amount of full payment and requests for confirmation (e.g., an audible “Yes” command) of the full payment request (step 604), which the bill payer 110 audibly provides by speaking such a confirmation (e.g., the word “Yes”) into the telephone receiver (step 606). In the event the bill payer 110 decides to make a minimum payment, the bill payer 110 then preferably speaks the word “Minimum” into the telephone receiver (step 608), after which the VEEBPP 100 preferably provides audible notification of the amount of minimum payment and requests for confirmation (e.g., an audible “Yes” command) of the minimum payment request (step 610), which the bill payer 110 audibly provides by speaking such a confirmation (e.g., the word “Yes”) into the telephone receiver (step 612). The VEEBPP 100 will of course preferably allow word choices other than those specified above.

Further, if the bill payer 110 decides to make a partial payment, then the bill payer 110 preferably speaks the word “Partial” into the telephone receiver (step 614). The VEEBPP 100 then preferably requests the bill payer 110 to speak of the partial payment amount to be made (step 616). The bill payer 110 responds with the payment amount by preferably speaking the amount (step 618) after which the VEEBPP 100 repeats of the spoken partial payment amount and requests for confirmation of this amount (step 620). The bill payer 110 then provides such confirmation by preferably speaking the word “Yes” into the telephone receiver (step 622).

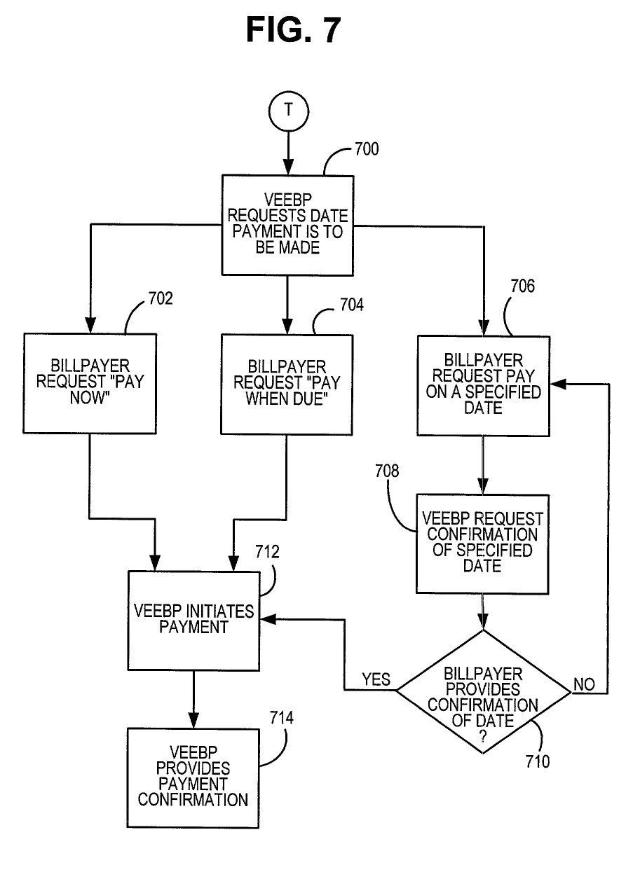

Further, if the bill payer 110 decides to state both payment type and date, then the bill payer 110 preferably speaks the payment amount and date into the telephone receiver (step 624). The VEEBPP 100 will repeat the information and request confirmation of the amount and date (step 626). The bill payer 110 then provides such confirmation by preferably speaking the word “Yes” into the telephone receiver (step 628). The VEEBPP 100 then proceeds to the payment subroutine “T1” as shown in FIG. 7, and described below. Regardless of whether the bill payment was a fill, minimum or partial payment, once the payment type has been established and confirmed, the VEEBPP 100 then proceeds with the payment timing subroutine “T” as shown in FIG. 7, as now described. In regards to payment timing, the VEEBPP 100 requests for payment date by preferably presenting three options to the bill payer 110, namely: “Pay Now”, “Pay When Due” and pay on a specified date (step 700). If the bill payer 110 wants to pay the amount now, the bill payer 110 preferably speaks “Pay Now” into the telephone receiver (step 702). Similarly, if the bill payer 110 wants to pay on the bill due date, the bill payer 110 preferably speaks “Pay When Due” into the telephone receiver (step 704). If the bill payer 110 wants to make payment on a certain date, then the bill payer 110 preferably speaks “Pay Bill On (bill payer specifies date)” into the telephone receiver (step 706). The VEEBP 100 then preferably repeats the date just given and requests confirmation that this is the correct date (step 708). Bill payer 110 then provides confirmation that this is the correct date (step 710). If no proper confirmation is provided, the VEEBPP 100 prompts the bill payer to restate the date (step 706).

Once the payment date has been established and confirmed, the VEEBPP 100 then initiates payment of the requested amount (step 600) on the requested date (step 712). Typically, and with reference to FIG. 2, this is performed with the VEEBPP 100 sending payment instructions (e.g., amount, account numbers, identity of bill originator bank) to the bill payers bank 114, which bank then communicates with the bill originator bank 116 to transfer the funds to the specified account. Once the funds have been transferred and the bill payer's account has been credited with the payment, confirmation of the bill payment is made (step 714) in accordance with the preferences established during the enrollment (step 423).

In summary, a voice enable electronic billing presentment and payment system has been described. Although the present invention has been described with emphasis on a particular embodiment, it should be understood that many changes and modifications may be made to the invention without departing from the scope and spirit of the invention as disclosed. For example, many modifications and adaptations to the preferred embodiment will be apparent to those skilled in the art. Further, those skilled in the art will appreciate that some aspects of the present invention will be used to advantage without the corresponding use of other aspects. The arrangement of bills and the form of record may be changed as desired and further, might be integrated with existing financial software packages such as electronic checkbook, tax or accounting systems.

Accordingly, the foregoing description of the preferred embodiment should be considered as merely illustrative of the present invention and not in limitation thereof.

What is claimed is:

1. A method for audibly providing billing services from an electronic billing server to a user, comprising:
initiating telephony connection between the electronic billing server and the user;
providing billing details in a spoken language from the electronic billing server to the user relating to a billing account associated with the user through the telephony connection;
providing payment instructions from the user to the electronic billing server relating to a payment associated with the user's billing account through the telephony connection; and
initiating an order from the electronic server to a user's bank to initiate the payment instructions associated with the user's billing account.

2. A method as recited in claim 1 further including the step of including a voice recognition system in the electronic billing server for recognizing a users spoken instructions.

3. A method as recited in claim 2 wherein the step of providing payment instructions from the user to the electronic billing server further includes the user providing spoken payement instructions to the electronic billing server.

4. A method as recited in claim 1 further including the steps of:
the user prescribing a preferred time period in the electronic billing server for initiating telephony connection with the user at a prescribed, telephone number; and
the user prescribing an alternative time period in the electronic billing server for initiating telephony connection with the user in the event no telephony connection is achieved during the preferred time period.

5. A method as recited in claim 4 further including the steps of:
the user prescribing alternative delivery methods for delivering the billing details to the user; and
sending the billing details to the user via at least one prescribed alternative delivery method in the event telephony connection was not established with the user during at least the preferred time period.

6. A method as recited in claim 1 wherein the step of providing billing details in a spoken language from the electronic billing server includes the step of the user selecting one format of billing details to be heard from a plurality of differing billing detail formats which are prescribed in the electronic billing server.

7. A method as recited in claim 1 wherein the step of providing payment instructions for the user includes the step of the user selecting one format of payment instructions to be sent to a users bank selected from a plurality of differing payment instruction formats that are offered and heard from the electronic billing server.

8. A method as recited in claim 4 wherein the step of initiating telephony connection with the user includes the step of the electronic billing server initiating telephony connection during the preferred time period.

9. A method as recited in claim 1 wherein the step of initiating telephony connection with the user includes the step of the user initiating telephony connection with the electronic billing server.

10. A method as recited in claim 1 wherein the step of providing billing details includes the step of the user selecting to hear billing details associated with one of a plurality of billing accounts associated with the user and prescribed in the electronic billing server.

11. A method for audibly providing billing services from an electronic billing server to a user, comprising:
including a voice recognition system in the electronic billing server for recognizing the user's spoken instructions and authenticating the user's voice;
the user prescribing alternative delivery methods in the electronic billing server for delivering billing details to the user in the prescribed alternative delivery method in the event telephony connection is not established with the user during a preferred time period;
initiating telephony connection between the electronic billing server and the user;
authenticating the user's voice via the voice recognition system after telephony connection has been established between the user and the electronic billing server;
providing billing details in a spoken language from the electronic billing server to the user relating to a billing account associated with the user through the telephony connection, which further includes the step of:
the user selecting to hear billing details associated with one of a
plurality of billing accounts associated with the user and
prescribed in the electronic billing server;
providing payment instructions from the user to the electronic billing server relating to a payment associated with the user's billing account through the telephony connection, which further includes the step of:
the user selecting one format of payment instructions to be sent to
a users bank selected from a plurality of differing payment instruction formats that are prescribed and heard from the electronic billing server; and
initiating an order from the electronic server to a user's bank to initiate the payment instructions associated with the user's billing account.

12. A method as recited in claim 11 wherein the step of providing payment instructions from the user to the electronic billing server further includes the user providing spoken instructions to the electronic billing server.

13. A method as recited in claim 11 further including the steps of:
the user prescribing a preferred time period the electronic billing server is to initiate telephony connection with the user using a prescribed telephone number; and
the user prescribing an alternative time period the electronic billing server is to initiate telephony connection with the user in the event no telephony connection is established during the preferred time period.

14. A method as recited in claim 13 wherein the step of initiating telephony connection with the user includes the step of the electronic billing server initiating telephony connection during the preferred time period.

15. A method as recited in claim 11 wherein the step of initiating telephony connection with the user includes the step of the user initiating telephony connection with the electronic billing server.

16. A method for audibly providing billing services from an electronic billing server to a user, comprising:
providing an electronic billing server containing billing information relating to at least one billing account associated with the user which is configured to audibly convey the billing information to the user in a spoken language through the user's telephone;
providing a voice recognition system in the electronic billing server for recognizing the user's spoken instructions and authenticating the user's voice;
the user prescribing alternative delivery methods in the electronic billing server for delivering billing details to the user in the prescribed alternative delivery method in the event telephony connection is not established with the user during a preferred time period;
initiating telephony connection between the electronic billing server and the user;
authenticating the user's voice via the voice recognition system after telephony connection has been established between the user and the electronic billing server;
providing billing details in a spoken language from the electronic billing server to the user relating to a billing account associated with the user through the telephony connection, which further includes the step of:
the user selecting to hear billing details associated with one of a
plurality of billing accounts associated with the user and
prescribed in the electronic billing server;
providing payment instructions from the user in a spoken language to the electronic billing server relating to a payment associated with the user's billing account through the telephony connection, which further includes the step of:
the user selecting one format of payment instructions to be sent to
a users bank selected from a plurality of differing payment instruction formats that are prescribed and heard from the electronic billing server; and
initiating an order from the electronic server to a user's bank to initiate the payment instructions associated with the user's billing account.

17. A method as recited in claim 16 further including the steps of:
providing billing information relating to a plurality of billing accounts each associated with the user in the electronic billing server with the electronic billing server being configured to audibly convey billing information to the user in a spoken language; and
selecting by the user one of the plurality of billing accounts to audibly hear, via the user's telephone, the billing information associated with the user selected billing account.

18. A method as recited in claim 16 further including the steps of:
the user prescribing a preferred time period the electronic billing server is to initiate telephony connection with the user using a prescribed telephone number; and
the user prescribing an alternative time period the electronic billing server is to initiate telephony connection with the user in the event no telephony connection is established during the preferred time period.
